(19) United States
(12) Patent Application Publication
(10) Pub. No.: US 2017/0199578 A1
(43) Pub. Date: Jul. 13, 2017

(54) Gesture control method for interacting with a mobile or wearable device

(71) Applicant: 16Lab Inc., Kamakura (JP)

(72) Inventors: Jan ROD, Singapore (SG); Rafael FERRIN, Tokyo (JP); Tõnu SAMUEL, Tallinn (EE)

(73) Assignee: 16Lab Inc., Kamakura (JP)

(21) Appl. No.: 15/401,482

(22) Filed: Jan. 9, 2017

Related U.S. Application Data
(60) Provisional application No. 62/276,436, filed on Jan. 8, 2016.
(60) Provisional application No. 62/276,706, filed on Jan. 8, 2016.

(51) Int. Cl. G06F 3/01; G06F 1/16

(52) U.S. Cl. CPC G06F 3/017; G06F 1/163; G06F 1/1694

(57) ABSTRACT

The aim of the present invention is to provide low-power gesture control method for mobile and wearable devices for interacting target devices. Furthermore, this invention presents a take on solving the modality switching problems known from prior art, where one modality can be used to activate another.

### PRIORITY

This application claims priority of U.S. provisional application No. 62/276,436 filed on Jan. 8, 2016 and U.S. provisional application No. 62/276,706 filed on Jan. 8, 2016, the contents of both of which are incorporated herein by reference.

### FIELD OF THE INVENTION

The disclosed method relates to the field of methods of interacting with the computing devices, more specifically to user interaction that employ specific natural hand motion to activate other specific user interface by a gesture.

### BACKGROUND OF THE INVENTION

Computers and other devices can be human voice operated. For example mobile phones can accept commands to call a phone number or to search for a nearby restaurant. Usually voice control must be activated first by some physical trigger-button press in mobile phones, mouse click in computers, handle pull in car hands-free systems.

Gesture sensing has been implemented on many consumer devices using both touch-enabled display surfaces (i.e. pinch to zoom) as well as body motion (i.e. activate smart watch display by raising forearm to a specific position). Majority of the gestures implemented in motion based systems use some instantiation of machine learning technologies to detect motion and recognize which interactions user performs. Machine learning, however, demands processing power that is often not available in low-power wearable devices. There is a specific need for low-power sensing methods that would provide an alternative with similar functionality, but significantly reduced demand for data processing, wireless data transmission and pattern recognition. With the onset of pervasive computing where users need to perform increasing number of operations, power optimization is in high demand to extend battery life of the wearable devices to reduce the need for frequent charging.

Another specific need that this method addresses is related to increasing modalities used in designing interactions with everyday electronics. These modalities can be implemented in one device, or be distributed across multiple devices (i.e. a wearable device attached to user's body and another device, such as her smartphone). Moreover, single personal computing device often offers increasing number of inputs-touch screens, physical buttons (and keyboards), voice, various physical ways of shaking or manipulating the device using motion sensors. In addition, combination with connected wearable electronics offers ways how these modalities can be switched or activated without directly interacting with the target device. For example, voice control on a smartphone can be activated by a hand gesture detected by wearable device, then command spoken into a wireless headset and output delivered also to a wireless headset, without a need for direct interaction with the main device. Systems used to do similar interconnection for switching contexts have been explored previously, such as in U.S. Pat. No. 8,744,645B1 “System and method for incorporating gesture and voice recognition into a single system”, or US2014168058A1 “APPARATUS AND METHOD FOR RECOGNIZING INSTRUCTION USING VOICE AND GESTURE” and US2014289778A1 “GESTURE AND VOICE RECOGNITION FOR CONTROL OF A DEVICE”.

### BRIEF DESCRIPTION OF THE INVENTION

The aim of the present invention is to provide low-power gesture control method for mobile and wearable devices for interacting target devices. Furthermore, this invention presents a take on solving the modality switching problems known from prior art, where one modality can be used to activate another.

According to the present invention the aim is achieved by providing a set of natural gestures that are easy to remember and perform with high precision, since they are based on natural interaction gestures, building upon previously acquired interaction paradigms. Furthermore, this invention provides a set of techniques how to achieve low-power sensing of these natural gestures.

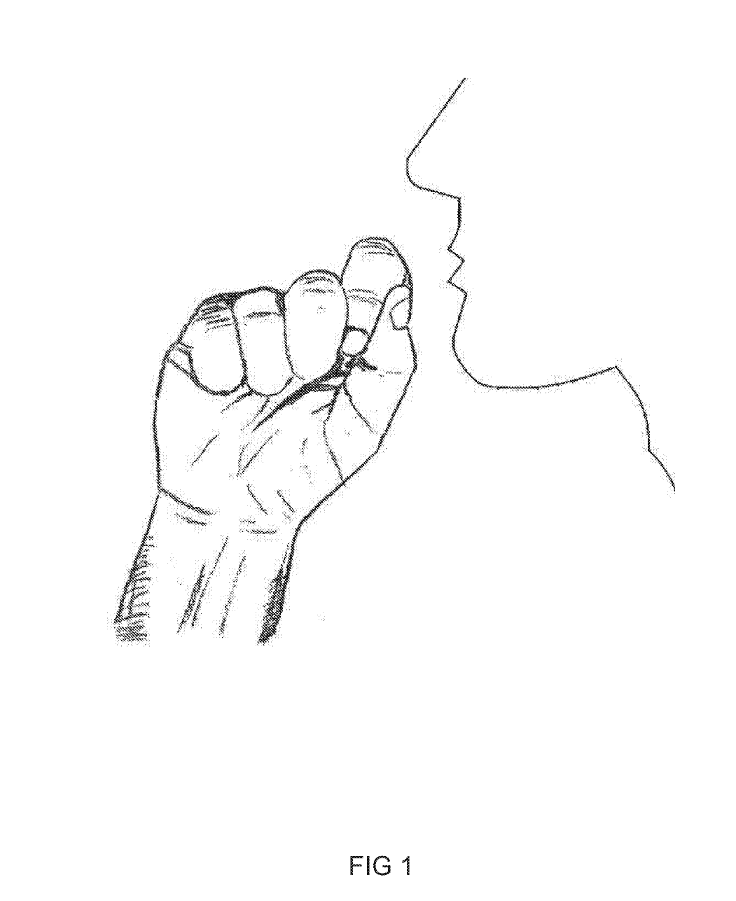

The present invention provides a specific interaction method for activating voice control (cf. FIG. 1), using wearable device, such as, smart watch, ring or a bracelet by gesture. In case of wearables such movement can be detected using angular speed, angle or gyroscopic sensor. By adding information about location of ground acceleration from acceleration sensor this can be made quite accurately. This gesture may or may not need extra trigger from user. For example smart ring can have just one button. Function of single button will be decided by context. Just moving limb around with ring may have no function or other function. But pressing trigger and then making “speak” gesture activates voice control. After that, user can use voice to give more commands to computing device.

The activation itself is performed by naturally moving user's hand to mouth, resembling speaking to microphone. User's movement is detected using angular speed, angle or gyroscopic sensor. To increase accuracy, we are combining data with ground acceleration from acceleration sensor. This gesture may or may not need extra trigger from user, such as using an additional button to initiate the sensing gesture sensing sequence, such as data flow between the wearable and another device performing the data analysis. Function of single button is decided by context, allowing for coexistence of this method with multiple other types of interactions, while pressing trigger and then performing this gesture activates voice control.

While using wearable devices (smart watches, smart bracelets, smart rings etc.) voice control can be activated doing the gesture of moving your hand near to your mouth, as if you were holding a small microphone on your fingers, as if you were pointing to your mouth or a similar gesture, intuitive and natural for the user.

The particularity of wearing some kind or wearable device on the hand or wrist makes it feasible and accurate the detection of this gesture and other we are registering on similar patents.

The user is wearing a ring, a wristband, a smart watch, any other wearable able to share information about the hand or arm movements and/or orientation or any combination of them. This invention detects when the wearables stay near to the predefined orientations (pose).

Additionally, for improving the accuracy of the invention, saving energy or making it more versatile for the user, this invention could include different triggering methods, like input from buttons, detection of taps on the surface of any of the wearables, detecting quasi-static periods on the predefined pose or any other way of triggering or improving the detection system.

### DETAILED DESCRIPTION OF THE DRAWINGS

The preferred embodiment of present invention is explained more precisely with references to figures added, where

FIG. 1 illustrates initial position of the present invention that includes wearable wristband and smart TV, wherein the user has a hand wearing the wristband in a generic relaxed position.

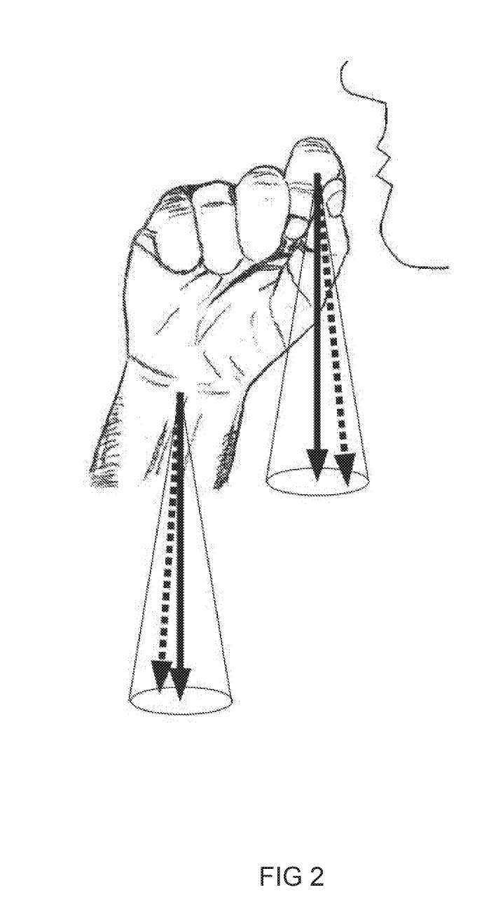

FIG. 2 illustrates Hand-to-Mouth Motion position, wherein the user presses the button and moves the hand towards the mouth to activate voice control functionality.

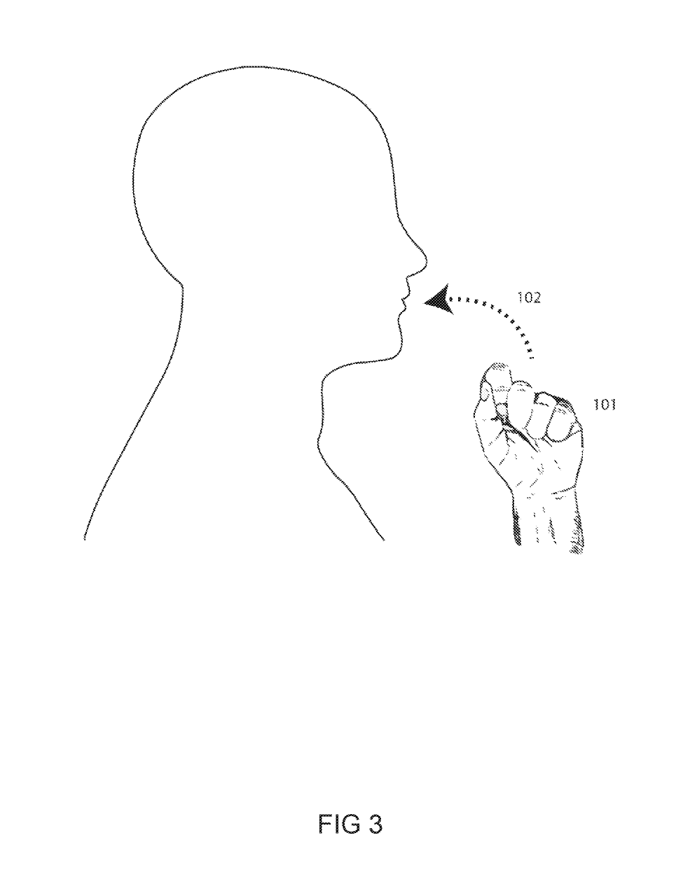

FIG. 3 illustrates Hand-to-Mouth Pose position, wherein user keeps the pose. System evaluates the pose together with the motion and activates the voice control functionality.

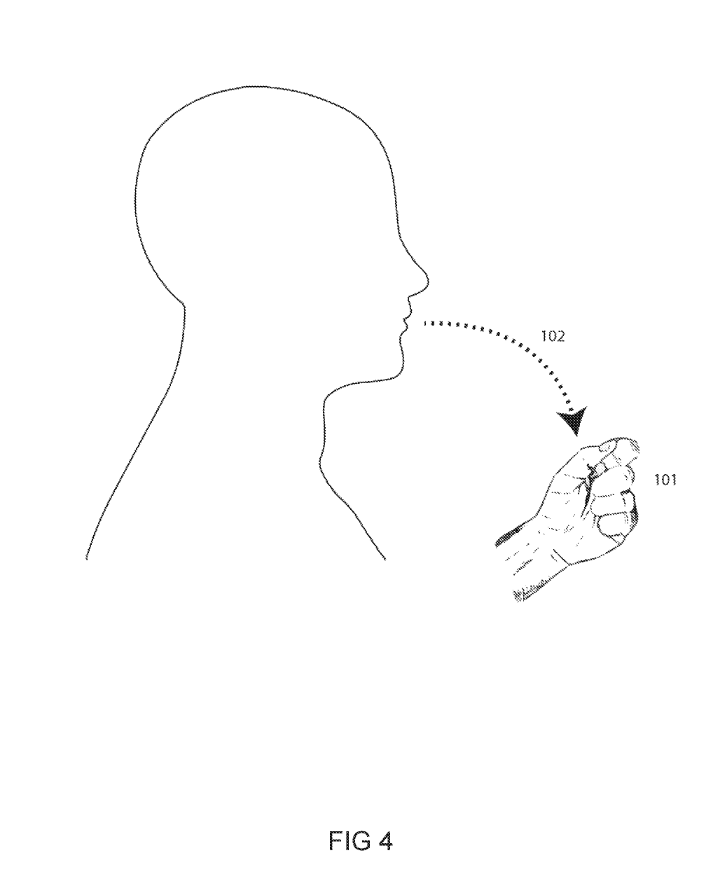

FIG. 4: describes end of the interaction where uses inputs the voice commands and releases trigger, wherein the system de-activates the voice assistant functionality.

### DETAILED DESCRIPTION OF THE INVENTION

The present method for interacting with a mobile or wearable device using a stream of data of any nature comprises steps of

### Configuration

predefining the set of initial poses of the device;

predefining the functionalities associated to those initial poses;

### Usage

adopting the initial pose for the desired functionality;

activating the trigger;

acquiring data from the sensors;

using the first values of the data to detect the initial pose;

determining the functionality according to the initial pose;

formatting the data (if required) for that functionality;

interpreting the rest of the input data stream according to that functionality.

In an alternative embodiment the present method for interacting with mobile or wearable devices using sensor data as input data comprises steps of:

predefining the set of initial poses of at least one device;

predefining the functionalities associated to those set of initial poses;

adopting the initial pose for the defined functionality; or adopting a sequence of initial and following poses for defined functionality;

activating the trigger (optional, if the device is equipped with the trigger);

acquiring data from the sensors of mobile or wearable device;

formatting and preprocessing the data if required (optional);

evaluating the data to detect the initial pose;

evaluating the data to detect additional poses;

determining the functionality according to defined additional pose;

using raw data for that functionality or formatting the data for that functionality;

interpreting the rest of the input data stream for further action.

The nature of the data used in the present invention could be for example inertial measurement unit (IMU), camera, linear and/or angular accelerometer, magnetometer, gyroscope, color sensor, electrostatic field sensor, tilt sensor, gps, backlight, clock, battery level, status of a Bluetooth connection or any other quantifiable parameter measuring unit related to the mobile device use or their combination). The data could be generated by the own device or received in any way.

The definition of the initial poses may include direct data values (battery level, orientation of the device, etc.) and data derived from the direct data values (orientation changes fast: the device is being shaken. GPS changes fast: transportation system, etc.). Therefore, some of the values of an initial pose are inputs from the user (orientation, shaking) and others are circumstantial. The ones chosen by the user are the key of the present invention, because they give the user the ability of selecting an initial pose (shake the device, put it vertical, etc.) before activating the trigger. As the user knows the possible initial poses, the selection of a pose is equivalent to the selection of a command to the device (type this letter, create a mouse pointer on the screen, switch off the TV, etc.).

The activation trigger could be a button on the device, a software function, the starting moment of a data streaming or any other method, function or command initiated by the user, by the device itself or by an external interaction.

One collateral advantage of this invention is that for many data sources as IMU or color sensors, for example, it is not necessary a previous formatting of the sensor data to be used as part of the initial pose. For example, an accelerometer raw value of acceleration over the X axis will be different depending on the hardware and configuration, but for similar orientations it will have similar values and during a shaking situation will oscillate considerably. Therefore both orientation and stability can be used as initial pose without formatting. Depending on the selected functionality after the initial pose the data could be specifically filtered or formatted for the selected functionality.

The working principle of the present method is as follows: a user is wearing a wearable device (a ring, a wristband, a smart watch, a headband, glasses frame, or any other form factor) equipped to sense orientation, speed, direction and other motion data about the movement of body part in question (upper body, head, limbs, digits and other extremities); the system then detects whether any (or more) of the wearable devices stays at or near the predefined position in space, or if it moves from one pre-defined pose to another by analyzing the motion data acquired from one or multiple sensors. Furthermore, for improving the accuracy of the system, as well as saving energy, the system ca be modified to employ different types of triggers, such as physical buttons, touch sensors, taps or detecting static periods, as well as specific types of motion in the predefined pose.

The pose is defined using raw data values (i.e. data acquired directly from sensors) as well and data processed using various algorithms from for example inertial measurement unit (IMU), camera, linear and/or angular accelerometer, magnetometer, gyroscope, color sensor, electrostatic field sensor, tilt sensor, GPS and other positioning systems, ambient light, microphone, clock, battery level, status of a Bluetooth connection, Wi-Fi or other wireless form of communication or any other quantifiable parameter measuring unit related to the mobile device use or their combination.

FIG. 2 describes an example of a speak gesture using a watch/wristband and a ring on the index finger, as the index finger is natural point of reference while interacting with other devices, as well as allows for natural interaction with a thumb (i.e. pushing a button on the ring device). The arrows on FIG. 2 represent the detected ground direction of each wearable and the dashed arrows represent the expected ground references for that gesture. The cones around the detected ground references represent the limits of the detection (at this example, 10 deg).

### Embodiments

A typical embodiment would comprise of wearable bracelet connected to a smart TV via wireless connection. When user wants to activate voice control input on the TV, she simply raises a hand with a bracelet towards the mouth. The TV, being the target device in this case, evaluates the motion data from the bracelet and once the motion of the bracelet followed by the pose is evaluated as matching the voice control activation, user is provided with a feedback that TV is ready for voice input.

In another embodiment, the user can use a smart TV controller equipped with motion sensor to achieve same functionality. In this case motion data can be given higher priority to achieve higher accuracy rate overcoming the problems arising from the fact that user can hold the device in numerous ways.

In an alternative embodiment, the user wears on their hand a wearable ring device equipped with an IMU and a target device serves as voice assistant (a computer or any other device). In this embodiment the target device acquires an orientation and acceleration data from the wearable device and when predefined conditions are met, the voice assistant is activated. User then proceeds to issue voice commands freely. Alternatively, in this and other embodiments, the voice input can be active only during the ongoing pose, allowing the voice assistant to deactivate automatically once the command input is finished.

1. A method for interacting with a mobile or wearable device using sensor data as input data comprising steps of
predefining a set of initial poses of the device;
predefining functionalities associated to those initial poses;
adopting an initial pose for a desired functionality;
activating a trigger;
acquiring data from sensors;
using first values of the data to detect the initial pose;
determining the desired functionality according to the initial pose;
formatting the data (if required) for that desired functionality;
interpreting rest of the input data stream according to that desired functionality.

2. The method according to claim 1, wherein the trigger activation is a function.

3. The method according to claim 1, wherein the trigger activation is a command initiated by the user.

4. The method according to claim 1, wherein acquiring input data comprises numeric values representing quantifiable parameters related to the mobile device use.

5. The method according to claim 1, wherein the rest of the input data is managed by different functions.

6. The method according to claim 1, wherein the rest of the input data is managed by the same function but with different parameters.

7. The method according to claim 1, wherein the rest of the input data is ignored.

8. The method according to claim 1, wherein the rest of the input data is managed by any other method.

9. A gesture control method for interacting mobile or wearable devices with target devices using sensor data as input data comprising steps of:
defining a set of initial poses of at least one mobile or wearable device;
predefining functionalities associated to those set of initial poses;
adopting an initial pose for the defined functionality; or adopting a sequence of initial and following poses for defined functionality;
activating a trigger (optional, if the system is equipped with the trigger);
acquiring data from sensors of mobile or wearable device;
formatting and preprocessing the data (optional);
evaluating the data to detect the initial pose;
evaluating the data to detect additional poses;
determining the functionality according to defined pose;
formatting the data (if required) for that functionality;
interpreting the rest of the input data stream for further action.

10. The method according to claim 9, wherein the trigger activation is a function.

11. The method according to claim 9, wherein the trigger activation is a command initiated by the user.

12. The method according to claim 9, wherein acquiring input data comprises numeric values representing quantifiable parameters related to the mobile device use.

13. The method according to claim 9, wherein the rest of the input data is managed by different functions.

14. The method according to claim 9, wherein the rest of the input data is managed by the same function but with different parameters.

15. The method according to claim 9, wherein the rest of the input data is ignored.

16. The method according to claim 9, wherein the rest of the input data is managed by any other method.
